(19) United States
(12) Patent Application Publication
(10) Pub. No.: US 2023/0211269 A1
(43) Pub. Date: Jul. 6, 2023

(54) DUST COLLECTOR APPARATUS

(71) Applicant: COSMEX CO. LTD., New Taipei City (TW)

(72) Inventors: Wan Chieh HSIEH, New Taipei City (TW); Pai Yao HSIEH, New Taipei City (TW); Chien Chieh TUNG, New Taipei City (TW)

(21) Appl. No.: 18/176,161

(22) Filed: Feb. 28, 2023

Related U.S. Application Data
(63) Continuation-in-part of application No. 16/533,481, filed on Aug. 6, 2019.

(30) Foreign Application Priority Data
Aug. 6, 2018 (TW) 107210745

(51) Int. Cl. B01D 46/00; B08B 15/04; B01D 46/44; B01D 46/52; B01D 46/42; B24B 55/06

(52) U.S. Cl. CPC B01D 46/0043; B08B 15/04; B01D 46/44; B01D 46/521; B01D 46/4245; B01D 46/0005; B01D 46/009; B01D 46/0086; B01D 46/4227; B01D 46/0036; B01D 46/0038; B01D 46/0028; B24B 55/06; B01D 2273/30; B01D 2279/65; A45D 29/00

(57) ABSTRACT

A dust collector apparatus includes a housing, an airflow generation module and a filter. The housing has one side formed at least one intake vent-hole and another side formed of at least one exhaust vent-hole. An inner side of the housing has an airflow channel formed between the intake vent-hole and the exhaust vent-hole. The airflow generation module comprises an airflow drawing unit for drawing an airflow in order to form the airflow channel between the intake vent-hole and the exhaust vent-hole, a control module for controlling the airflow drawing unit, and a power module. The filter is detachably arranged at the intake end and used for filtering dust in the air sucked by the airflow drawing unit. The dust collector apparatus of the present invention allows the dust particles to be properly collected by the filter without secondary scattering, and guides the airflow to be exhausted smoothly.

### BACKGROUND OF THE INVENTION

### 1. Technical Field

The present invention is related to a dust collector apparatus, in particular, to a dust collector apparatus with a detachable filter and equipped with an airflow guidance function.

### 2. Description of Related Art

In recent years, nail art becomes popular worldwide. Regardless whether it is to modify the original nail color to create natural nail appearance or to decorate nails with accessories and painting of unique colors and shapes for nail beauty, nail art has become an important aspect of fashion and style.

In the process of nail styling, to create the texture of nail or to remove the original nail styling products, such as curing gel etc., it is necessary to perform polishing on the nails. However, during the polishing process, a great amount of powder and dust are generated inevitably. In addition, the powder and dust can be of different particle size, and dust of large particle sizes tends to aggregate together and settle, whereas particles of small particle sizes tends to scatter to the surrounding of the environment, causing dust piling at various areas of the room, such that it can lead to dirty environment and the safety risk of fire or explosion. Furthermore, for nail beauty customers and nail stylists, they can be exposed to hazards of human bodies due to inhaling micro articles of nails or nail styling products in a long term. Accordingly, there is a need for a dust collector apparatus in the nail beauty market for dust collection in order to prevent scattering of dust and powder.

A common conventional dust collector apparatus is to directly suck the dust into the dust collector apparatus during the polishing process, and the dust passes through a turbulence wind turbine to be collected in a dust collection bag or dust collection box. After the dust is collected to a certain amount, it can be cleaned off in order to allow the continuous use of the dust collection bag or dust collection box.

### BRIEF SUMMARY OF THE INVENTION

Presently, there are dust collector devices in the market capable of collecting dust generated during the nail beauty process; nevertheless, such known dust collector devices use the mechanical parts of wind turbine etc. to generate the airflow suction force in order to directly suck in the airflow with dust into the dust collector devices via the wind turbine. However, such type of design often causes the wind turbine to be jammed with dust and requires periodic cleaning of the wind turbine to prevent malfunction. In addition, they also require the vent-hole of the housing of such dust collector devices for cleaning the dust collector bag or box, such that they can be extremely inconvenient to use. Furthermore, during the running of the wind turbine, heat is generated by the wind turbine, and it can cause odor when it is in contact with the dust, or can even cause the hazard of explosion. Moreover, since the dust generated from nail beauty is often of great amount but light in weight, the dust is likely to scatter outward if the airflow inside the dust collector apparatus is disturbed, such that conventional dust collector devices are of poor dust collection efficiency.

As above, to solve the problems, the present invention provides a dust collector apparatus, comprising: a housing having one side formed at least one intake vent-hole and another side formed of at least one exhaust vent-hole, an inner side of the housing having an airflow channel formed between the intake vent-hole and the exhaust vent-hole, wherein the intake vent-hole is in position of a top side of the housing, and the exhaust vent-hole is in position of a lateral side instead of an opposite side aligned to the intake vent-hole of the housing; an airflow generation module, comprising: at least one airflow drawing unit for drawing an airflow in order to form the airflow channel between the intake vent-hole and the exhaust vent-hole, the airflow drawing unit having an intake end for sucking an air and an exhaust end for exhausting the air; a control module electrically connected to the airflow drawing unit, the control module comprising a control board for controlling the airflow drawing unit; a power module electrically connected to the control module; and at least one filter detachably arranged at the intake end and used for filtering dust in the air sucked by the airflow drawing unit.

In a preferred embodiment, the airflow drawing unit comprises a axial flow fan, the airflow generation module further comprises an airflow guiding drawing unit, the airflow guiding drawing unit comprises an upper airflow guide aligned to an upper side of the axial flow fan, and a lower airflow guide aligned to a bottom side of the axial flow fan.

In a preferred embodiment, the upper airflow guide has a bell mouth gradually enlarged from lower side to upper side, the lower air guide has a central protrusion portion aligned to middle of the axial flow fan, and a guiding curved surface surrounding the central protrusion portion to guide the airflow from vertical direction to horizon direction by Coanda effect.

In a preferred embodiment, the upper airflow guide's bottom side is appressed to the upper side of the axial flow fan, a top side of the central protrusion portion is adjacent to the bottom side of the axial flow fan and having a gap in-between.

In a preferred embodiment, an opening of the bell mouth is smaller than the axial flow fan, and the diameter of the bell mouth's opening is less than the diameter of the axial flow fan between 1.5 mm to 2.5 mm.

In a preferred embodiment, the width of the gap is between 1.5 mm to 2.5 mm, and the height of the central protrusion portion is between 15 mm to 25 mm.

In a preferred embodiment, wherein the airflow drawing unit comprises a centrifugal fan, the airflow generation module further comprises an airflow guiding drawing unit for containing the centrifugal fan inside, the airflow guiding drawing unit has a surrounding wall around the periphery of the centrifugal fan, an inlet opening on the top side aligned to the centrifugal fan, and an outlet opening align to a side of the centrifugal fan in a horizontal direction.

In a preferred embodiment, the width of the outlet opening is between 85 mm to 95 mm.

In a preferred embodiment, the distance between a middle of the centrifugal fan and the surrounding wall is gradually declined from a first lateral side of the outlet opening to a second lateral side of the outlet opening.

In a preferred embodiment, the housing has a c-type input plug connected to the power module.

In a preferred embodiment, the filter is a filter selected from a group consisting of an absorption layer, filter layer, sedimentation layer, chemical catalyst layer, photocatalyst layer, electrostatic layer, ionization layer or a combination thereof.

In a preferred embodiment, the housing comprises a positioning member for positioning the filter, and the positioning member comprises a mortise and tenon joint structure, latch structure, locking engagement structure, space restriction structure, magnetic attraction structure, spring structure, elastic sheet structure, screw fastening structure, sensor or a combination thereof.

In a preferred embodiment, the positioning member is a sensor comprising a sensing unit electrically connected to the control module for sensing an installation status of the filter.

In a preferred embodiment, the airflow generation module comprises an operation module electrically connected to the control module and is used to control the state of use of the airflow drawing unit.

In a preferred embodiment, the power module comprises any one of an external power port, a one-time battery, a rechargeable battery or a combination thereof.

In a preferred embodiment, the control module further comprises (a) a detection module and (b) a warning device connected to the detection module; wherein the detection module detects at least one of the following states: (1) a state of use of the filter, such that when the detection module detects the state of use of the filter exceeding or below a threshold value or the filter is installed at the incorrect position, the detection module transmits a message to the display unit or the warning device in order to display a notice for filter replacement or correction; (2) a state of the airflow generation module, such that when the detection module detects the airflow generation module is not operated normally, the detection module transmits a message to the display unit or the warning device; (3) a state of the power module, such that when the detection module detects the power state for the dust collector apparatus is low, the power module does not properly be connected or abnormal power supply, the detection module transmits a message to the display unit or the warning device.

In a preferred embodiment, the warning device is selected from the group consisting of a buzzer, a loudspeaker and an indicating light.

In a preferred embodiment, wherein the filter has multiple creases on the surface for increasing the contacting area and the containing quantity of the dust.

In a preferred embodiment, the housing comprises a handle arranged at an outer side of the housing.

In a preferred embodiment, the airflow generation module comprises a supporting layer installed at the intake end of the airflow drawing unit, and the intake vent-hole are formed thereon, the filter is placed between the housing and the supporting layer, the housing has a lateral opening at the side end such that the filter is taken from the lateral opening without dissembling the housing.

Comparing to the conventional techniques, the present invention has the following advantages: The dust collector apparatus of the present invention can comprise a filter, and such filter can be a composite filter, such as a filter containing photocatalyst, active carbon etc., in order to allow the dust collector apparatus of the present invention to have not only the dust collection function but also the function of deodorization and disinfection on the filtered air, thereby achieving the effect of air purification at the same time.

### BRIEF DESCRIPTION OF THE SEVERAL VIEWS OF THE DRAWINGS

FIG. 1 is an outer appearance perspective view of the first embodiment of the present invention.

FIG. 2A is a top exploded view of the first embodiment of the present invention.

FIG. 2B is a bottom exploded view of the first embodiment of the present invention.

FIG. 3 is a top view of the first embodiment of the present invention.

FIG. 4 is the first embodiment's sectional view according to the section line A-A of FIG. 3.

FIG. 5A is a top exploded view of the second embodiment of the present invention.

FIG. 5B is a bottom exploded view of the second embodiment of the present invention.

FIG. 6 is a top view of the second embodiment of the present invention.

FIG. 7 is the second embodiment's sectional view according to the section line B-B of FIG. 6.

FIG. 8 is a side view of the second embodiment of the present invention.

FIG. 9 is the second embodiment's sectional view according to the section line C-C of FIG. 8.

FIG. 10 is an outer appearance perspective view of the third embodiment of the present invention.

FIG. 11 is a top view of the third embodiment of the present invention.

FIG. 12 is the third embodiment's sectional view according to the section line D-D of FIG. 11.

FIG. 13 is a perspective view of an embodiment of the present invention showing the use state in which the filter 12 is pulled out from the dust collector apparatus 100 through the lateral opening 120.

FIG. 14 is a perspective view of an embodiment of the present invention showing the use state in which the stand 116 is arranged on the housing 11 in order to allow the housing 11 to be at a particular angle or height.

FIG. 15 is a perspective view of an embodiment of the present invention showing the use state in which the light unit (400) is detachably installed on the dust collector apparatus 100.

FIG. 16 is a perspective view of an embodiment of the present invention showing the use state in which the nail drill machine 500 is detachably installed on the dust collector apparatus 100.

FIG. 17 and FIG. 18 are perspective views of an embodiment of the present invention embedded in the table 600.

FIG. 19 is a perspective view of an embodiment of the present invention showing the use state in which the dust collector apparatus 100 is embedded in the table 600, and the nail drill machine 500 and the light unit 400 are detachably installed on the dust collector apparatus 100.

### DETAILED DESCRIPTION OF THE INVENTION

The details and technical solution of the present invention are hereunder described with reference to accompanying drawings. For illustrative sake, the accompanying drawings are not drawn to scale. The accompanying drawings and the scale thereof are not restrictive of the present invention.

The use of “comprise” means not excluding the presence or addition of one or more other components, steps, operations, or elements to the described components, steps, operations, or elements, respectively. Similarly, “comprise”, “comprises”, “comprising”, “include”, “includes”, “including”, “has”, “have” and “having” are interchangeable and not intended to be limiting. As used herein and in the appended claims, the singular forms “a,” “an,” and “the” include plural referents unless the context dictates otherwise. The terms “a”, “an,” “the,” “one or more,” and “at least one,” for example, can be used interchangeably herein.

The details and embodiments of the present invention are hereunder described. However, it should be understood that the embodiments are just used to help understand the present invention and are not restrictive of the present invention.

The dust collector apparatus described herein is not limited to the application of nail art, and it can also be used for other purposes requiring air filtering or dust collection, such that the scope of the application for the dust collector apparatus of the present invention is not limited.

### I. First Embodiment

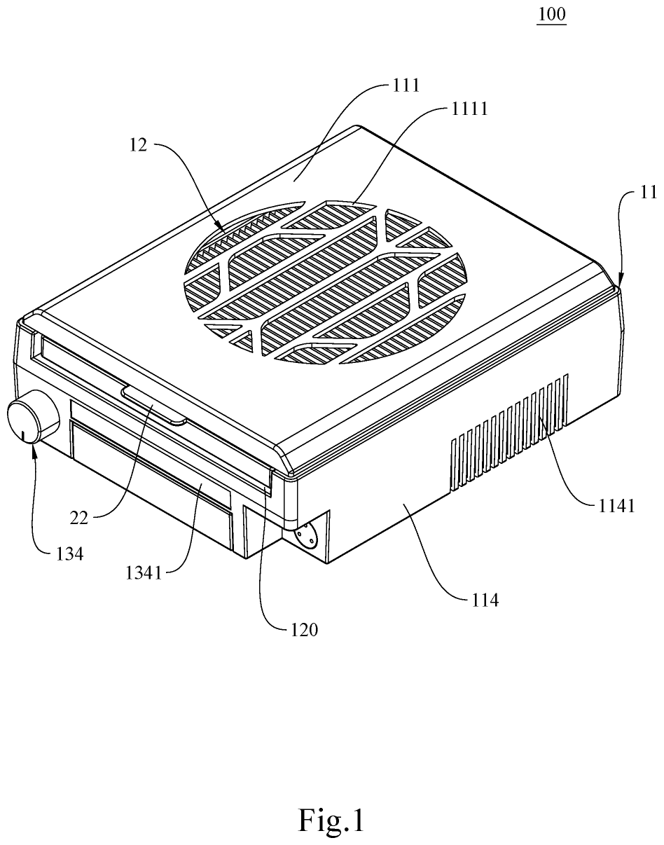

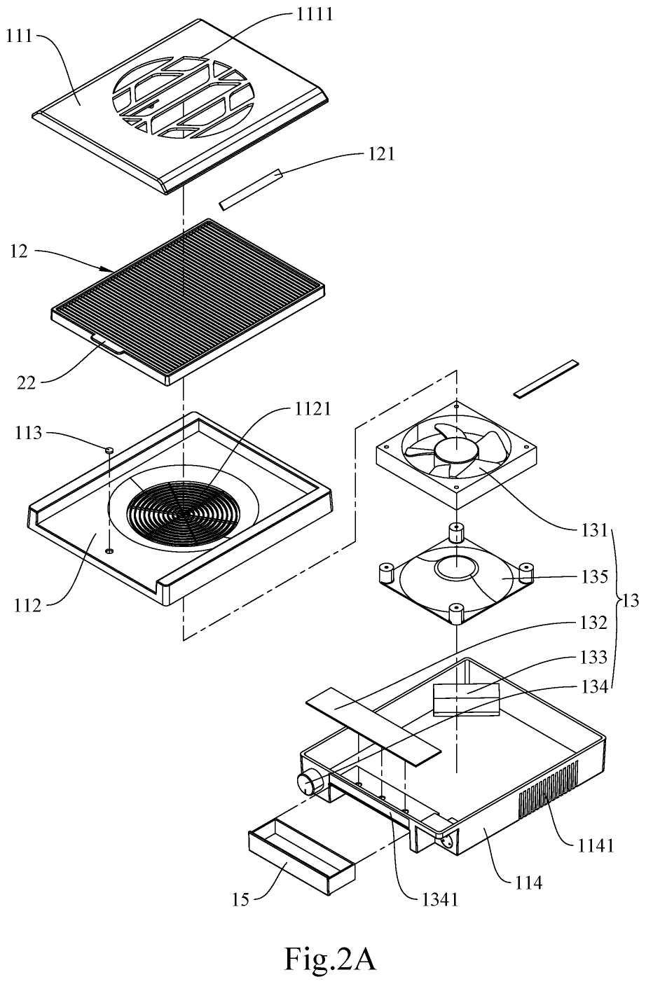

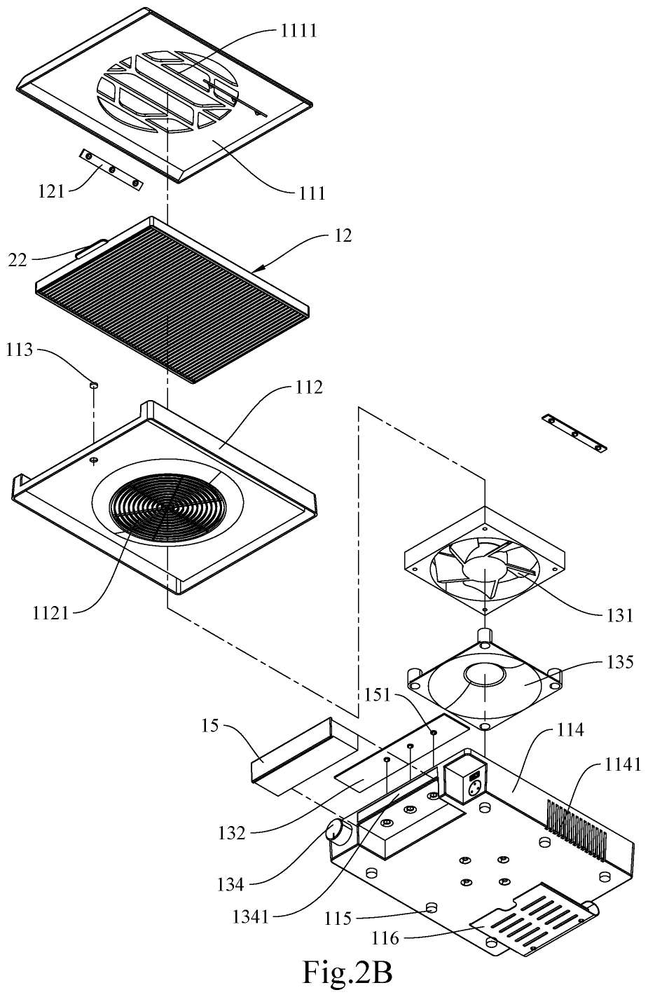

Please refer to FIG. 1, FIG. 2A and FIG. 2B, showing an outer appearance perspective view, top and bottom exploded views of the first embodiment of the present invention respectively. As shown in the drawings:

According to a first embodiment of the present invention, the dust collector apparatus 100 comprises: a housing 11, a filter 12 and an airflow generation module 13. The airflow generation module 13 comprises an airflow drawing unit 131, a control module 132 and a power module 133, wherein the airflow drawing unit 131 is used for drawing the airflow in and generating suction power; therefore, it includes an intake end for sucking an air and an exhaust end for exhausting the air. In addition, the number of the airflow drawing unit 131 can be single or plurality according to the user's need.

The housing 11 includes one side formed of at least one intake vent-hole 1111 and another side formed of at least one exhaust vent-hole 1141, and an inner side of the housing 11 includes an airflow channel formed between the intake vent-hole 1111 and the exhaust vent-hole 1141. Wherein the intake vent-hole 1111 is in position of a top side of the housing 11, and the exhaust vent-hole 1141 is in position of a lateral side of the housing 11 As an example, the housing 11 can be integrally formed or can comprise an upper cover and a lower cover, or a left cover and a right cover etc.; however, the housing 11 of the present invention is not limited to such configuration only. In this embodiment, the housing 11 comprises an upper cover 111, and a lower cover 114 (as shown in FIG. 1). The dust collector apparatus 100 further comprises a supporting layer 112. The upper cover 111 and the supporting layer 112 are arranged at the intake end, and the intake vent-holes (1111, 1121) are formed thereon. In addition, the filter 12 is placed between the upper cover 111 and the supporting layer 112. The filter 12 can be detachably installed at the location of the intake end. The lower cover 114 is able to receive the airflow generation module 13, and the side end and/or bottom end of the lower cover 114 is formed of at least one exhaust vent-hole 1141.

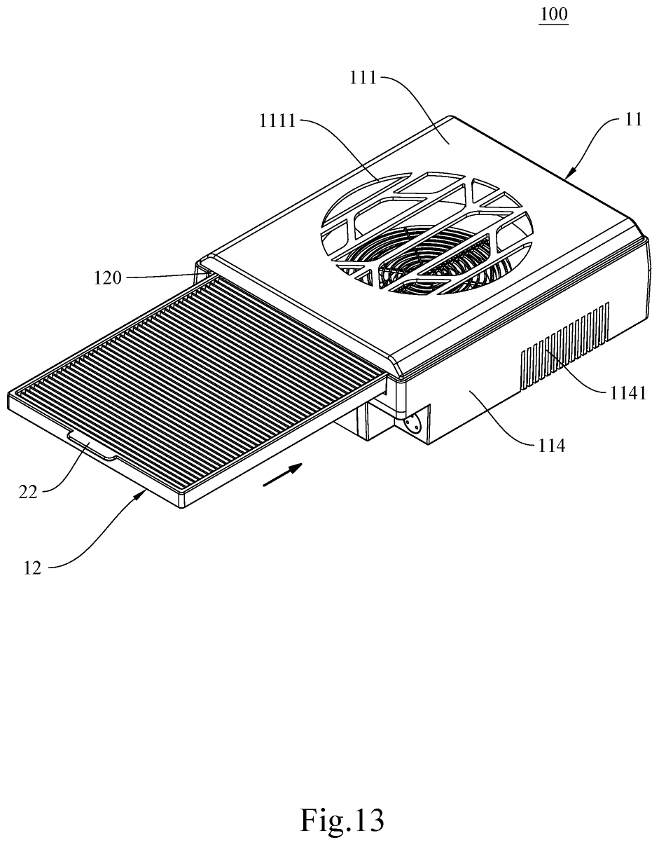

The filter 12 is used for filtering the dust contained air sucked by the airflow drawing unit 131. In a preferred embodiment, the filter 12 is detachably installed at an inner side of the housing 11 corresponding to the intake vent-holes (1111, 1121). For example, by dissembling the upper cover 111 from the housing 11, the filter 12 can be taken out. In another embodiment, the housing 11 has a lateral opening 120 at the side end and the filter 12 can be taken from the lateral opening 120 without dissembling the housing 11. For example, the filter 12 has a tag 22 corresponding to the lateral opening 120, such that without dissembling the housing 11, a user can pull out the filter 12 from the dust collector apparatus 100 by pulling the tag 22 (as shown in FIG. 13). Another example is that the housing 11 has a bounce unit such that the filter 12 can be released from the dust collector apparatus 100 without dissembling the housing 11. The filter 12 can be a filter selected from a group consisting of an absorption layer, filter layer, sedimentation layer, chemical catalyst layer, photocatalyst layer, electrostatic layer, ionization layer or a combination thereof. In a preferred embodiment, the filter 12 is a high-efficiency filter (or known as high-efficiency air particle filter). In another preferred embodiment, the filter 12 comprises an absorption layer and a photocatalyst layer, wherein the absorption layer is active carbon. The advantage of this embodiment relies in that the dust collector apparatus 100 of the present invention can be used to filter dust, and the active carbon can also absorb odor particles; in addition, the photocatalyst layer can perform deodorization, disinfection and sterilization etc. on the air. Accordingly, it is able to achieve the effect of air purification during the dust removal. In a preferred embodiment, the filter has multiple creases on the surface, such the creases will provide the downward concaves for containing the dust, so as to increase the contacting area and the containing quantity of the dust.

In a preferred embodiment, the housing 11 further comprises a sterilization lamp 121, and the sterilization lamp 121 emits sterilization lights toward the filter 12. Example of the sterilization lamp 121 includes but not limited to UVB LED bulb or UVC LED bulb. In a preferred embodiment, the filter 12 can be a disposable filter that can be replaced with new ones. In another preferred embodiment, the filter 12 can be removed for cleaning such that it is a reusable type of filter. To facilitate the replacement, cleaning and installation of the filter 12, the housing 11 can include a foolproof means of a position indicator or positioning member 113 etc. in order to prevent the filter 12 from being installed into the dust collector apparatus 100 in an incorrect direction. The term “positioning” described in this content refers to a member for restricting or positioning during the installation of the filter 12 by the user, or a member for facilitating the user to directly or indirectly determine the installation position of the filter 12. The installation position refers to the installation direction, orientation, forward/reverse, location, sequence, angle etc. of the filter 12, but not limited to: shape matching, retention matching, drawing matching, color indication etc. In a preferred embodiment, the dust collector apparatus 100 further comprises a storage drawer 15 combined on one side of the housing 11 for storing the tools or nail tips inside, and another sterilization lamp 151 disposed inside of the housing to face to the containment space of the storage drawer 15, to sterilize the objects inside of the storage drawer 15.

The positioning member 113 can be, such as, but not limited to: mortise and tenon joint structure, latch structure, locking engagement structure, space restriction structure, magnetic attraction structure, spring structure, elastic sheet structure, screw fastening structure, or sensor (such as: pressure sensor, magnetoresistance sensor, optical sensor, infrared sensor) etc. The foolproof means of the present invention includes any one of the aforementioned position indication means and positioning member 113 etc. or a combination thereof as an example provided for illustration, and the content of the present invention is not limited to any type thereof. In a preferred embodiment, the positioning member 113 comprises a sensing unit electrically connected to the control module 132 and used for sensing an installation status of the filter 12, such as, but not limited to: installation location, installation direction, or the installation sequence of each filter sensed in an embodiment having a plurality of layer of filters. In a preferred embodiment, the positioning member 113 is an optical sensor or an infrared sensor, comprising a sensing unit electrically connected to the control module 132, and it can be installed on the housing 11, on the supporting layer 112 or can be installed on the control module 132. The sensing unit comprises a light emitter and a light receiver arranged at two sides corresponding to the filter 12 respectively in order to understand the installation status of the filter 12 based on the optical or infrared receiving status of the sensing unit. In a preferred embodiment, the positioning member 113 is a pressure sensor, comprising a pressure sensing unit electrically connected to the control module 132, wherein the filter 12 is used as a sensed unit.

The advantage of the dust collector apparatus 100 of the present invention installed with the filter positioning member 113 relies in that users can immediately understand whether the filter 12 is installed correctly during the installation, such that it can prevent the situation where the filter 12 installation is found to be improper after a period of time of use of the apparatus. Moreover, in an embodiment where a multiple layer of filters are used, the positioning member 113 is preferable to sense the installation sequence of each filter. For example, the positioning member 113 can be an optical sensor, and a specific location on the filter can be designed with a protrusion capable of intercepting light, and a light emitter and a light receiver can be correspondingly arranged at two sides of the filter respectively; therefore, after the filter is installed, the light can be detected to determine whether it is being intercepted, thereby sensing whether the filter is installed improperly, causing the installation sequence of the multiple layers of filters to be incorrect etc. However, it can be understood that the means adopted by the positioning member 113 to sense the installation sequence of each filter in the present invention is not limited to such configuration only. The installation method described is mainly based on the consideration that each layer of filter may have different function: (such as: particle filter, photocatalyst sterilization, and odor absorption etc.), and the arrangement sequence of filters of different functions can affect the outcome of air purification. Consequently, by maintaining the installation correctness of sequence, direction and forward/reverse of the filters, the multiple layers of filters are able to achieve the maximum effect and to prolong the useful lifetime of the filters.

The housing 11 can further comprise a soft pad (not shown in the drawings), at least one footpad 115, at least one stand 116, an outer cover (not shown in the drawings) and/or a handle (not shown in the drawings).

The soft pad (not shown in the drawings) is preferably arranged at an adjacent side of the intake vent-hole 1111 in order to allow the user to rest his or her hand thereon during the nail polishing process, thereby improving the comfort of the dust collector apparatus 100 of the present invention.

The footpad 115 is arranged at a lower end of the housing 11, and it is preferably of the anti-slip effect, in order to allow the dust collector apparatus 100 to be placed on any type of platforms for operation. The installation of the footpad 115 is able to elevate the dust collector apparatus 100 in order to prevent it from direct contact with the platform surface of desktop, thereby reducing noise generated during the running of the airflow generation module 13; in addition, in an embodiment where the exhaust vent-hole 1141 is installed at the bottom end of the housing 11, it is able to facilitate the airflow to be exhausted smoothly.

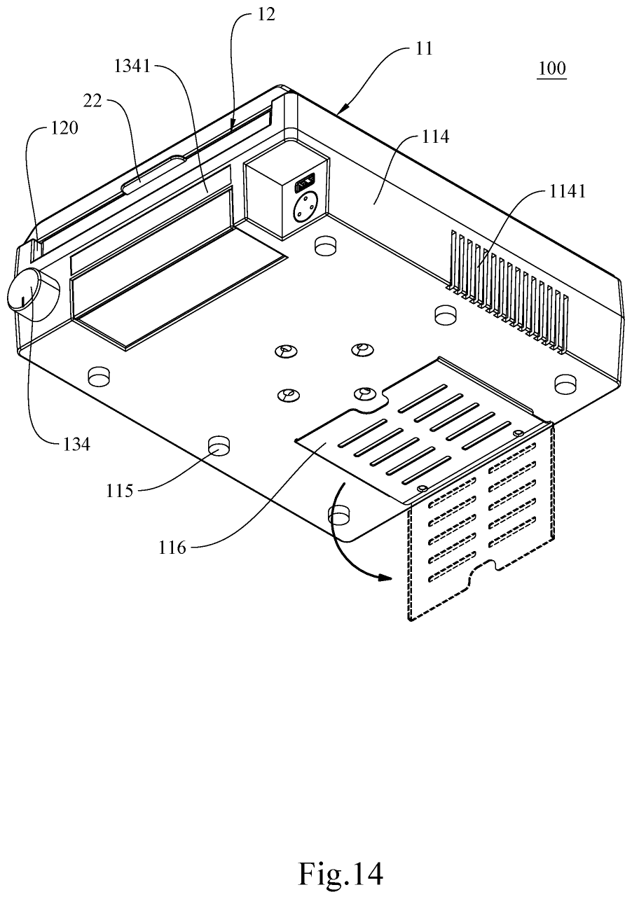

The stand 116 is arranged on the housing in order to allow the housing to be at a particular angle or height, thereby allowing the user to perform most optimal arrangement of the dust collector apparatus according to different operations, as shown in FIG. 14, the stand 116 is reversible according to a pivot mechanism, in a preferred embodiment, the pivot mechanism can further has a clutch gear (not shown in the drawings) or plurality of clutch gears, to enable the housing to be fixed in a particular angle and allow the intake vent-hole to work in variable directions. Another embodiment is that the housing does not comprise the stand, but the housing itself has an inclination angle, such that the housing is at a particular angle or height.

The outer cover (not shown in the drawings) can be detachably installed at an external of the intake vent-hole 1111. When the dust collector apparatus 100 is not in use, the outer cover can be installed at the external of the intake vent-hole 1111 to prevent dust; in addition, it can also prevent the filter 12 from unnecessary consumption due to absorbing particles or catalyst etc.

The handle (not shown in the drawings) can be arranged at an outer side of the housing 11 in order to allow the user to use hand to grip or to move the dust collector apparatus. The handle can be rotating handle or a fixed handle. In a preferred embodiment, the handle adopts a detachable means to be attached onto the housing 11 or it is integrally formed with the housing 11; wherein the detachable means includes but not limited to: latch structure, mortise and tenon joint structure or screw fastening structure etc., and the present invention is not limited to any configuration thereof.

The airflow drawing unit 131 is used for drawing the airflow in, thereby generating the airflow channel between the intake vent-hole (1111, 1121) and the exhaust vent-hole 1141. The airflow drawing unit 131 can be a mechanism, device, component part or a combination thereof equipped with the function of airflow drawing, and examples of such unit include but not limited to: a centrifugal fan (such as: multi-blade type, turbine-type, radial type, air foil type), axial flow fan, diagonal flow fan, cross flow fan, air multiplier etc. In a preferred embodiment, the airflow generation module 13 of the dust collector apparatus 100 of the present invention comprises an airflow guiding drawing unit 135, and the airflow guiding drawing unit 135 can include one or multiple types of fading surfaces in order to form a guiding curved surface for guiding the airflow. The airflow guiding drawing unit 135 is arranged corresponding to the exhaust end of the airflow drawing unit 131. Furthermore, according to different air flowing methods of the airflow drawing unit 131, the airflow guiding drawing unit 135 can be correspondingly arranged at different locations of the exhaust end of the airflow drawing unit 131.

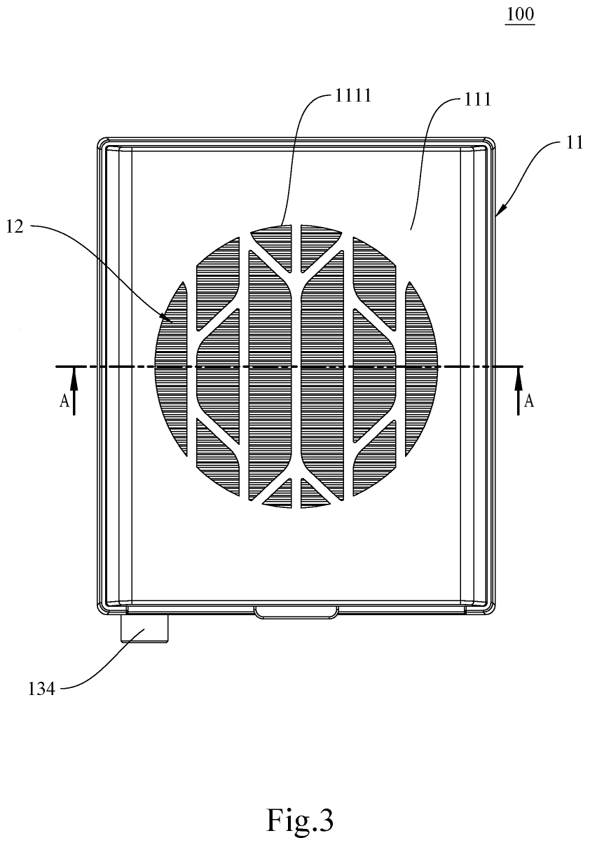

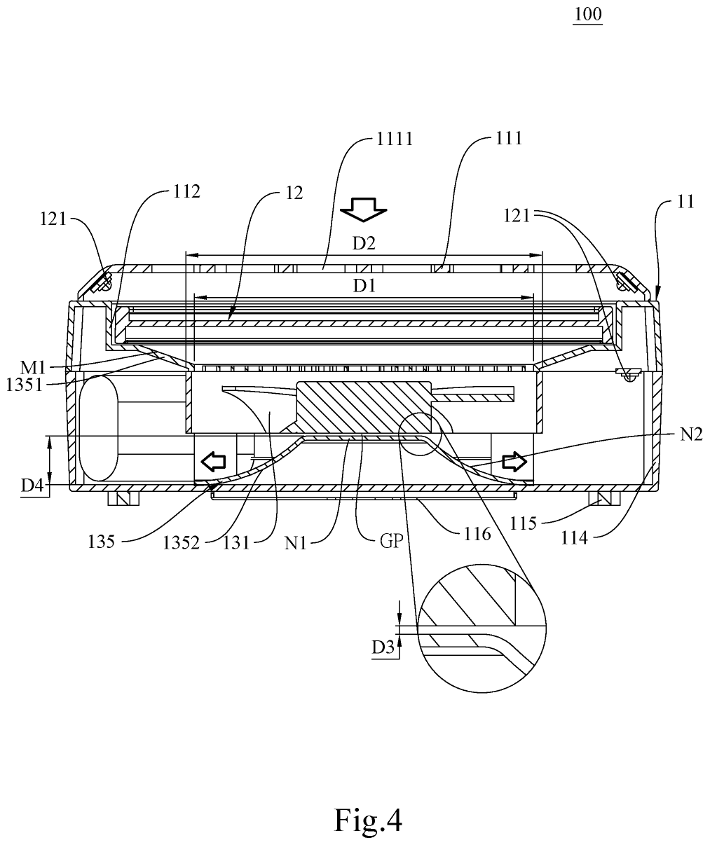

In this embodiment, please refer to FIG. 3 and FIG. 4, showing the top view and the sectional view (according to the section line A-A of FIG. 3) of the first embodiment of the present invention. As shown in the drawings: The arrows in FIG. 4 indicate the air flowing direction, and the airflow generation module 13 of the present invention uses the airflow drawing unit 131 to generate the drawing force during the operation thereof, thereby allowing the external air containing dust to contact with the filter 12. The filter 12 then retains the dust particles and allows the air to pass through. After the air passes through the airflow drawing unit 131, it contacts with the airflow guiding drawing unit 135. Since the airflow guiding drawing unit 135 has a smooth curved surface design, it is able to smoothly guide the air to the at least one exhaust vent-hole 1141 of the housing 11. Consequently, it is able to achieve a smooth airflow channel.

In a preferred embodiment, the airflow drawing unit 131 can be a mechanism, device, component part or a combination thereof equipped with the function of airflow drawing. In the embodiment shown in FIGS. 2A, 2B, 3 and 4, the airflow drawing unit 131 of the dust collector apparatus 100 is an axial flow fan, and the airflow generated flows perpendicular to the blade wheel, and its advantage relies in that the air volume generated is large. In order to exchange the direction of the airflow from the axial direction to the radial direction, the airflow guiding drawing unit 135 has an upper airflow guide 1351 aligned to an upper side of the axial flow fan, and a lower airflow guide 1352 aligned to a bottom side of the axial flow fan. More specifically, the upper airflow guide 1351 has a bell mouth M1 gradually enlarged from lower side to upper side. The lower air guide 1352 has a central protrusion portion N1 aligned to middle of the axial flow fan, and a guiding curved surface N2 surrounding the central protrusion portion N1 to guide the airflow from vertical direction to horizon direction by Coand\check{a} effect. In a preferred embodiment, the upper airflow guide 1351's bottom side is appressed to the upper side of the axial flow fan, a top side of the central protrusion portion N1 is adjacent to the bottom side of the axial flow fan and having a gap GP in-between, and an opening of the bell mouth M1 is smaller than the axial flow fan (please refer to FIG. 4, the diameter D1 of the bell mouth M1's opening is smaller than the diameter D2 of the axial flow fan's upper surface).

In a preferred embodiment, the diameter of the bell mouth M1's opening is less than the diameter of the axial flow fan between 1.5 mm to 2.5 mm, e.g. 1.5 mm, 1.6 mm, 1.7 mm, 1.8 mm, 1.9 mm, 2.0 mm, 2.1 mm, 2.2 mm, 2.3 mm, 2.4 mm, or 2.5 mm, such the numerical values are not limited in the present invention. Such the configurations avoid the disturbance of the airflow, and according to Bernoulli Effect, the lower airflow guide 1352 will produce a central vacuum area onto the gap GP between the axial flow fan and the central protrusion portion N1, to allow the radial airflow flowing evenly.

In a preferred embodiment, the width D3 of the gap GP is between 1.5 mm to 2.5 mm, and the height D4 of the central protrusion portion is between 15 mm to 25 mm, e.g. the width of the gap GP can be 1.5 mm, 1.6 mm, 1.7 mm, 1.8 mm, 1.9 mm, 2.0 mm, 2.1 mm, 2.2 mm, 2.3 mm, 2.4 mm, or 2.5 mm, and the height of the central protrusion portion can be between 15 mm, 16 mm, 17 mm, 18 mm, 19 mm, 20 mm, 21 mm, 22 mm, 23 mm, 24 mm or 25 mm, such the numerical values are not limited in the present invention.

It must be explained first, the term having “module” described in the present invention can be controlled and executed by one or multiple processors or microprocessors, and the communication method (such as physical circuit or wireless) is not limited. The processor or microprocessor may be coupled to or have a storage unit to execute the corresponding program and the operation of the device.

The control module 132 is electrically connected to the airflow drawing unit 131, and it comprises a control board for controlling the airflow drawing unit 131. The control module 132 can also be installed inside the housing 11.

The power module 133 is electrically connected to the control module 132. The power module 133 can be any one of an external power port or a battery or a combination thereof; wherein the battery can be a one-time battery or a rechargeable battery. In a preferred embodiment, the dust collector apparatus 100 has an input port, which can be used to power the dust collector apparatus 100 using a wall adapter, car charger, laptop USB port, or mobile power bank for ultimate portability. In a preferred embodiment, the power module 133 comprises any one of an external power port, a one-time battery, a rechargeable battery or a combination thereof. In addition, a battery compartment (not shown in the drawings) is formed by the side end, upper end or bottom end of the housing 11, and the battery compartment comprises a slot opening at the end of the battery compartment. Therefore, the battery is removable from the battery compartment through the slot opening without disassembling the housing 11 from the dust collector apparatus 100. In a preferred embodiment, the input port can be a c-type input plug connected to the power module 133 and/or the control module 132, providing electrical power to the above devices from the external power sources.

The airflow generation module 13 can further comprise an operation module 134. The operation module 134 is electrically connected to the control module 132 and is used to control the connection or the state of use of the airflow drawing unit 131; in addition, it can further comprise an operation interface for adjusting a wind speed and switch on/off of the airflow drawing unit 131 or a display unit 1341 for displaying operation commands, status information or battery level etc. The operation interface and the display unit 1341 are preferably installed in the housing 11. The operation interface can be, such as, but not limited to: any one of an operation key, operation pedal, operation button, adjusting knob, variable resistor, operation panel, touch screen or a combination thereof. The display unit 1341 can be, such as, but not limited to: any one selected from a group consisting of a touch-control monitor, display monitor, numerical monitor and indicator lights or a combination thereof.

Furthermore, the control module 132 of the present invention can selectively comprise a detection module and a warning device connected to the detection module (not shown in the drawings); examples of the warning device include but not limited to a buzzer, a loudspeaker and an indicating light. The detection module is electrically connected to the display unit 1341. The detection module refers to an element combination capable of directly or indirectly obtaining the state of use of the filter 12, and/or the airflow generation module 13, and/or the power module 133, which can comprise hardware or software, or can be further integrated with auxiliary parts. The hardware can comprise, such as, at least one sensor, microprocessor for data processing and other relevant elements (such as: signal amplifier, communication element, power element unit). The software can comprise, such as, data collection or characteristic obtaining software, signal amplification software, data algorithm analysis software etc. The present invention shall not be limited to any of the aforementioned hardware, software and auxiliary parts of the detection module. It must be explained first, for an embodiment without the detection module, the control module 132 may have a microprocessor to electrically connect to any devices of the dust collector apparatus 100 for processing the control function or distributing power and/or signal.

In an embodiment, the detection module of the dust collector apparatus 100 of the present invention is used to detect an air quality of the air sucked in by the dust collector apparatus 100 and/or an air quality of the air exhausted thereby, such as: substances of PM10, PM2.5, volatile organic compounds (VOC), CO₂, CO etc. Therefore, the detection module comprises at least one sensor (such as: PM10 sensor, PM2.5 sensor, VOC sensor, CO₂ sensor, CO sensor etc.) corresponding to the targeted detection substances as well as a microprocessor communicated or electrically connected to the sensor. The microprocessor converts the signals obtained from the aforementioned sensor and transmits to the display unit 1341 in order to indicate or display the air quality result via the display monitor or display lights etc. In another embodiment, a detection module can be also provided corresponding to the filter 12 for detects the dust quantity of the filter 12, and evaluates the remaining lifetime of the filter 12, such the detection module may has an optical sensor or a weight sensor for detecting the quantity of the dust on the filter. In addition, the microprocessor can be pre-stored with an air quality threshold value, such that when the air quality score obtained from the sensor and converted by the microprocessor is below the threshold value, the microprocessor can indicate or display the state for replacement of the filter on the display monitor or display light of the display unit 1341. Furthermore, when it is used in an embodiment with a plurality of layers of filters 12, the microprocessor can be pre-stored with a plurality of quality threshold values of the targeted air detected substances, such that when the individual air quality score obtained by the sensor and converted by the microprocessor is below the threshold value, the microprocessor can indicate or display the state for replacement of the individual filter 12 on the display monitor or display light of the display unit 1341 or the warning device can generate warning signal to a user.

In an embodiment, the detection module detects whether the filter 12 is installed at the correct position (such as using the positioning member for sensing an installation status of the filter), if the filter 12 is installed at the incorrect position, the detection module transmits a message to a display unit 1341 or the warning device in order to display a notice for filter replacement or correction.

In an embodiment, the detection module of the dust collector apparatus 100 of the present invention is used to detect the accumulated usage time of the filter 12 of the dust collector apparatus 100, for example, the detection module comprises a sensor, a timer with the time accumulation function and a microprocessor. In addition, the filter 12 is installed with an element for detection, and such element for detection is preferably a label (such as RFID) with a serial number for the identification by the sensor wirelessly. During the operation of the dust collector apparatus 100, the sensor detects the element for detection on the filter and also activates the timer to perform the accumulation of the running time. The microprocessor can be pre-stored with an accumulated usage time threshold value, such that when the accumulated usage time of the element for detection (i.e. the filter 12) obtained by the microprocessor has exceeded the threshold value, the microprocessor is able to indicate or display the state for replacement of the filter on the display monitor or display light of the display unit 1341.

In another embodiment, the detection module of the dust collector apparatus 100 of the present invention is used to detect whether the airflow generation module 13 is operated normally. For example, if the airflow generation module 13 cannot generate airflow, the generated airflow does not meet the wind speed controlled by the control module 132 or any foreign material being stuck into the airflow drawing unit 131, the detection module transmits a message to the display unit 1341 or the warning device.

In another embodiment, the detection module of the dust collector apparatus 100 of the present invention is used to detect the power status of the dust collector apparatus 100. For example, if the detection module detects the power state for the dust collector apparatus 100 is low, the battery is dead, or the external power port is not plugged in or the battery is not placed in the right position, the detection module transmits a message to the display unit 1341 or the warning device.

In an embodiment, for achieving the detection function according to the feedback signal from the output device (such as the state of the airflow generation module 13 or the power status of the dust collector apparatus 100), the detection module may not use sensors.

### II. Second Embodiment

Compared to the first embodiment, the difference between the second and the first embodiment relies in that the configuration of the airflow guiding drawing unit, since other mechanisms or devices are the same as the first embodiment, the same will not be repeated unnecessarily here below.

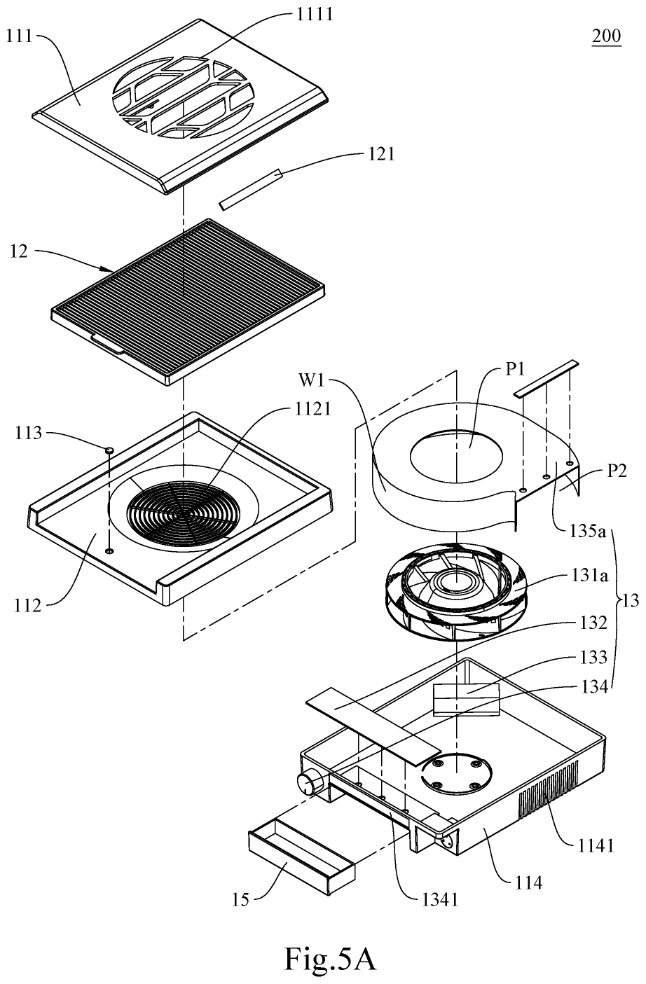

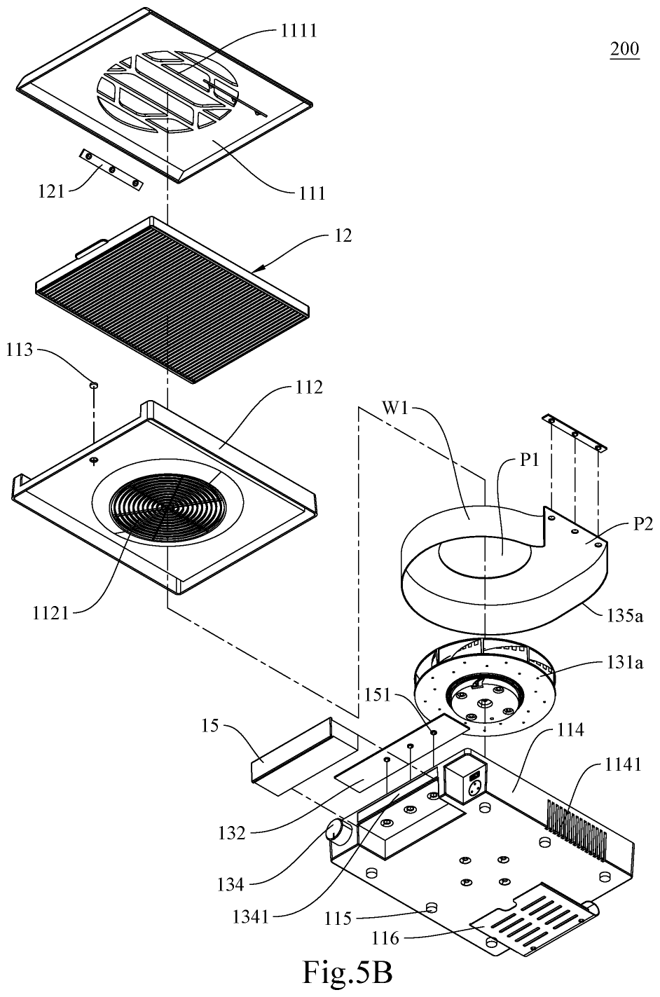

Please refer to FIG. 5A and FIG. 5B, showing the top and bottom exploded views of the second embodiment of the present invention respectively. As shown in the drawings: The second embodiment has disclosed a dust collector apparatus 200, which comprises the same as the first embodiment, but the airflow drawing unit of the dust collector apparatus 200 is a centrifugal fan 131a. Specifically, the present embodiment's airflow generation module 13 comprises a centrifugal fan 131a, and an airflow guiding drawing unit 135a. The airflow guiding drawing unit 135a contains the centrifugal fan 131a inside. Wherein, the airflow guiding drawing unit 135a has a surrounding wall W1 around the periphery of the centrifugal fan 131a, an inlet opening P1 on the top side aligned to the centrifugal fan 131a, and an outlet opening P2 align to a side of the centrifugal fan 131a in a horizontal direction. In a preferred embodiment, the width of the outlet opening P2 is between 85 mm to 95 mm, e.g. 85 mm, 86 mm, 87 mm, 88 mm, 89 mm, 90 mm, 91 mm, 92 mm, 93 mm, 94 mm, or 95 mm, such the numerical values are not limited in the present invention.

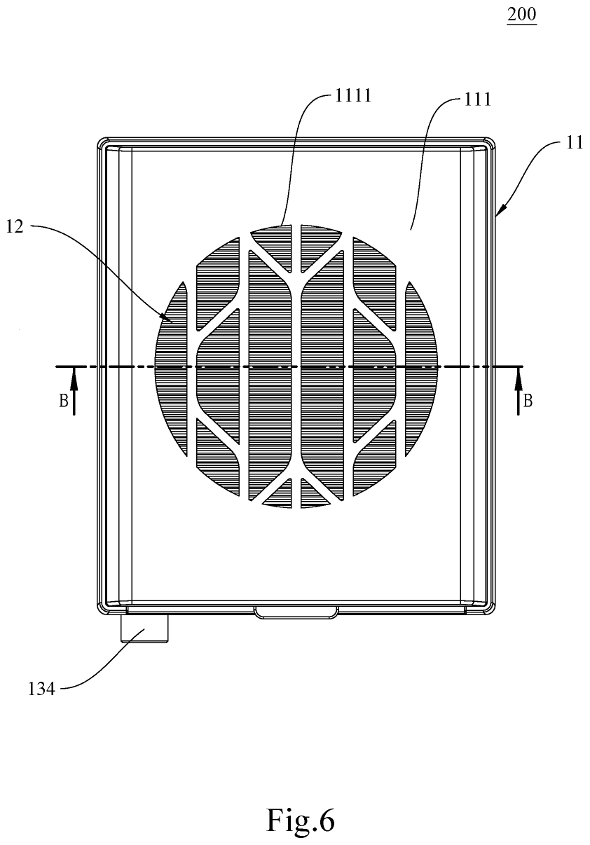

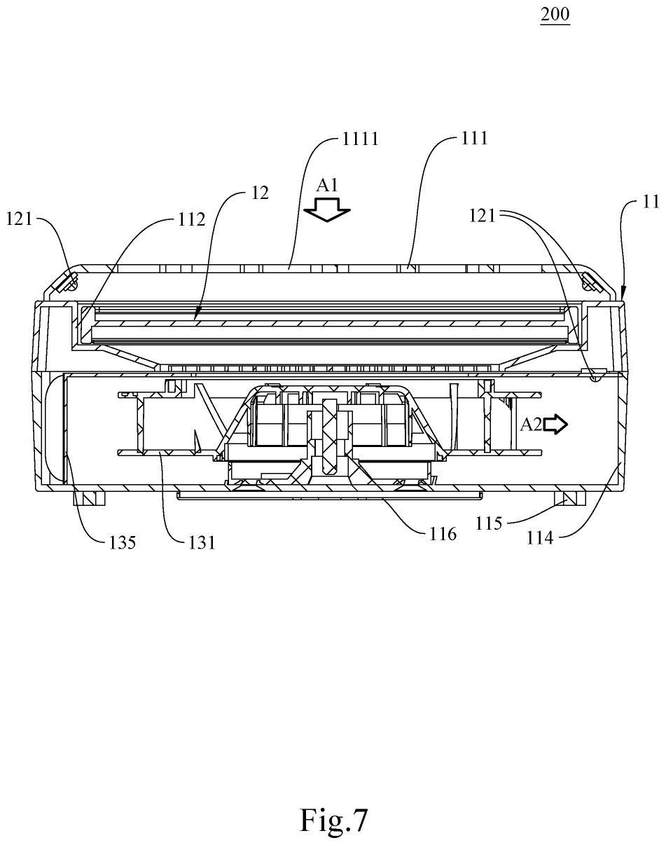

Please refer to FIG. 6 and FIG. 7, showing a top view of the second embodiment and the second embodiment's sectional view according to the section line B-B of FIG. 6 of the present invention respectively. As shown in the drawings: In this embodiment, the centrifugal fan 131a provided the vacuum attraction force onto the intake vent-hole 1111 on the top surface of the housing 11 (see arrow A1), and guiding the airflow from the vertical direction to the horizon direction to concentrate the airflow going through the outlet opening P2 (see arrow A2).

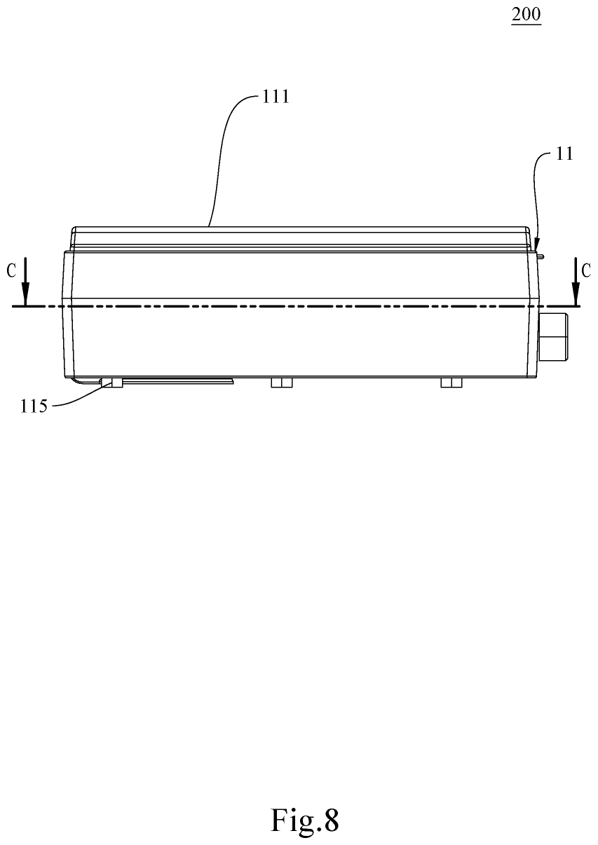

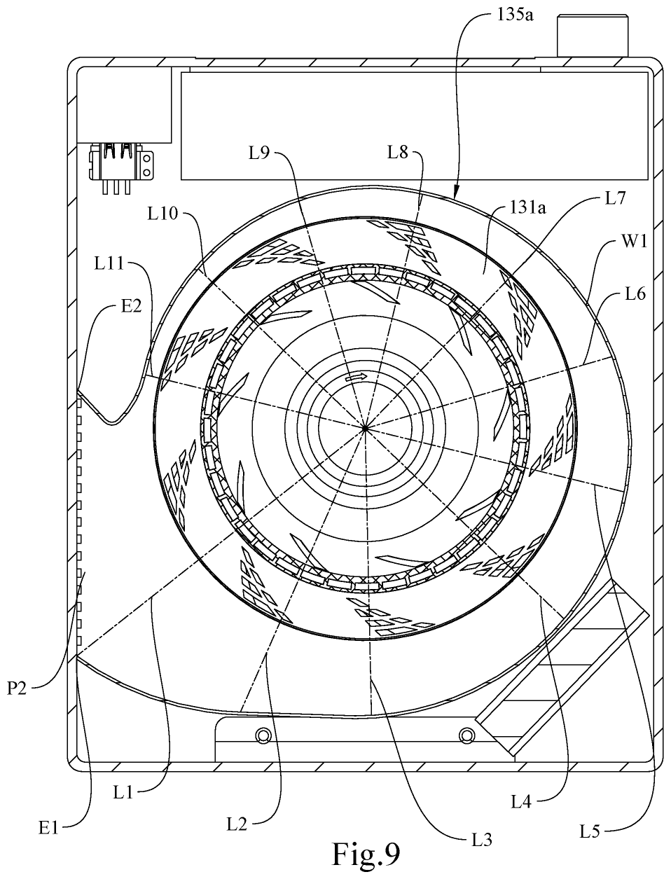

Please refer to FIG. 8 and FIG. 9, showing a side view of the second embodiment and the second embodiment's sectional view according to the section line C-C of FIG. 8 of the present invention respectively. As shown in the drawings: In this embodiment, for providing a large airflow; In a preferred embodiment, the distance between a middle of the centrifugal fan 131a and the surrounding wall W1 is gradually declined from a first lateral side E1 of the outlet opening P2 to a second lateral side E2 of the outlet opening P2. For example, the distance (connecting line L1) between the middle of the centrifugal fan 131a and the first lateral side E1 is 131.8 mm; Starting from the above connecting line L1, further rotating 28 degrees counterclockwise according to the middle of the centrifugal fan 131a as the center, the distance (connecting line L2) between the middle of the centrifugal fan 131a and the surrounding wall W1 is 111.5 mm; Starting from the above connecting line L2, further rotating 25 degrees counterclockwise according to the middle of the centrifugal fan 131a as the center, the distance (connecting line L3) between the middle of the centrifugal fan 131a and the surrounding wall W1 is 102.5 mm; Starting from the above connecting line L3, further rotating 45 degrees counterclockwise according to the middle of the centrifugal fan 131a as the center, the distance (connecting line L4) between the middle of the centrifugal fan 131a and the surrounding wall W1 is 98.0 mm; Starting from the above connecting line L4, further rotating 30 degrees counterclockwise according to the middle of the centrifugal fan 131a as the center, the distance (connecting line L5) between the middle of the centrifugal fan 131a and the surrounding wall W1 is 95.0 mm; Starting from the above connecting line L5, further rotating 30 degrees counterclockwise according to the middle of the centrifugal fan 131a as the center, the distance (connecting line L6) between the middle of the centrifugal fan 131a and the surrounding wall W1 is 92.0 mm; Starting from the above connecting line L6, further rotating 30 degrees counterclockwise according to the middle of the centrifugal fan 131a as the center, the distance (connecting line L7) between the middle of the centrifugal fan 131a and the surrounding wall W1 is 88.5 mm; Starting from the above connecting line L7, further rotating 30 degrees counterclockwise according to the middle of the centrifugal fan 131a as the center, the distance (connecting line L8) between the middle of the centrifugal fan 131a and the surrounding wall W1 is 86.5 mm; Starting from the above connecting line L8, further rotating 30 degrees counterclockwise according to the middle of the centrifugal fan 131a as the center, the distance (connecting line L9) between the middle of the centrifugal fan 131a and the surrounding wall W1 is 85.0 mm; Starting from the above connecting line L9, further rotating 30 degrees counterclockwise according to the middle of the centrifugal fan 131a as the center, the distance (connecting line L10) between the middle of the centrifugal fan 131a and the surrounding wall W1 is 82.8 mm; Starting from the above connecting line L10, further rotating 30 degrees counterclockwise according to the middle of the centrifugal fan 131a as the center, the distance (connecting line L11) between the middle of the centrifugal fan 131a and the surrounding wall W1 is 81.0 mm.

### III. Third Embodiment

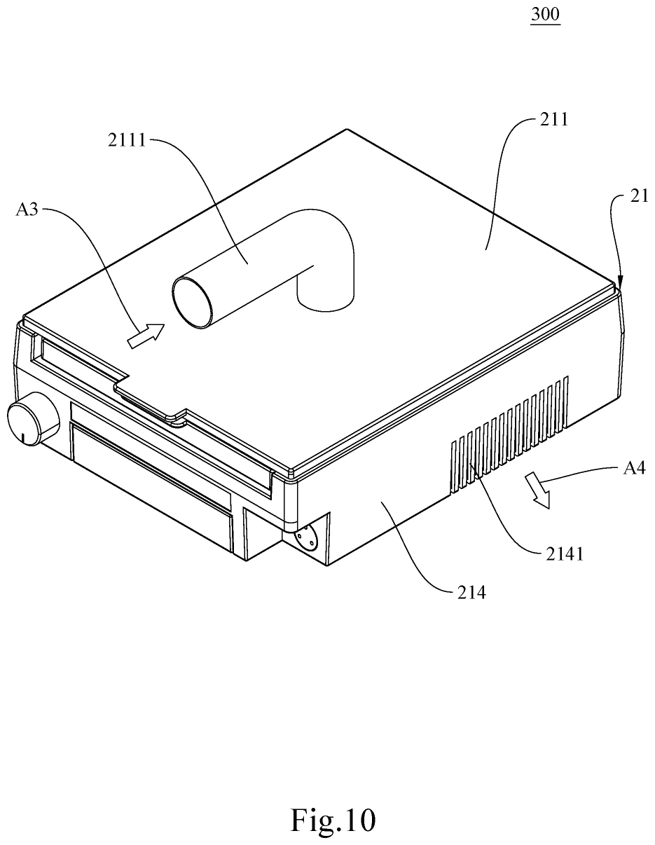

Please refer to FIG. 10 to FIG. 12, showing an outer appearance perspective view, top view, airflow channel view of a third embodiment of the dust collector apparatus 300 of the present invention. As shown in the drawings: In the third embodiment of the present invention, the dust collector apparatus 300 of the present invention comprises: a housing 21, a filter 22 and an airflow generation module 23; wherein the airflow generation module 23 is used for generating a suction force; therefore, it includes an intake end and an exhaust end.

The housing 21 comprises a top cover 211, and a lower cover 214. The dust collector apparatus 300 further comprises a supporting layer 212 and the top cover 211 and the supporting layer 212 are arranged at the intake end and are formed of an intake vent-hole (2111, 2121) thereon. In addition, the filter 22 is placed between the top cover 211 and the supporting layer 212. The filter 22 is arranged at an location corresponding to the location of the intake end of the airflow generation module 23. The lower cover 214 is able to receive the airflow generation module 23, and the lower cover 214 includes a plurality of exhaust vent-holes 2141 at the side end. The inner side of the housing 21 includes an airflow channel.

The difference between the third embodiment and the first embodiment relies in that the housing 21 includes a tubular intake vent-hole 2111. In a preferred embodiment, the aforementioned tubular intake vent-hole is formed directly from the housing. In a preferred embodiment, the aforementioned tubular intake vent-hole is formed by a tube installed at the intake vent-hole of the housing (such as the intake vent-hole of the top cover in the first embodiment with an additional installation of a tube in order to form the configuration of the third embodiment). In a preferred embodiment, the aforementioned tubular intake vent-hole is formed by a cover member with a tubular intake vent-hole installed directly onto the external of the intake vent-hole of the housing (such as the outer side of the top cover in the first embodiment with an additional installation of a cover member with a tubular intake vent-hole in order to form the configuration of the third embodiment). The aforementioned tubular intake vent-hole can be a fixed type, and preferably to be an adjustable type, such as, but not limited to: flexible, extendable or rotatable type of adjustment methods. In addition, it can be added with a plurality of movable positioning sections (such as ball joint or flexible coil) in order to allow the user to adjust the orientation and height of the tubular intake vent-hole 2111. In a preferred embodiment, the tubular intake vent-hole 2111 of the dust collector apparatus 300 is a coil, plastic or rubber wrapped flexible metal tubular member, a plastic tube with proper supporting force, or other materials or structures capable of allowing the tubular intake vent-hole 2111 to be bent or rotated in any direction or angle, such that the flexibility of the use of the dust collector apparatus 300 of the present invention is increased. Except for the above, the rest of the configuration of the dust collector apparatus 300 is identical to the configuration of the first embodiment.

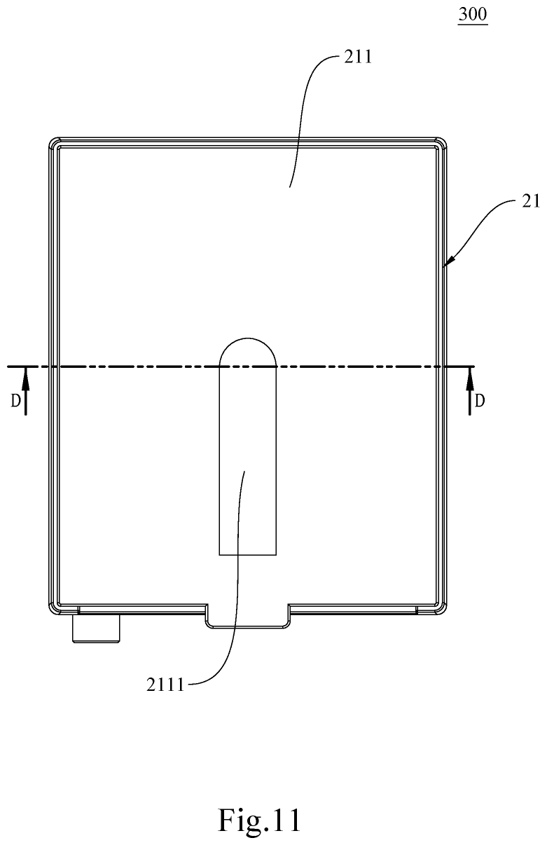

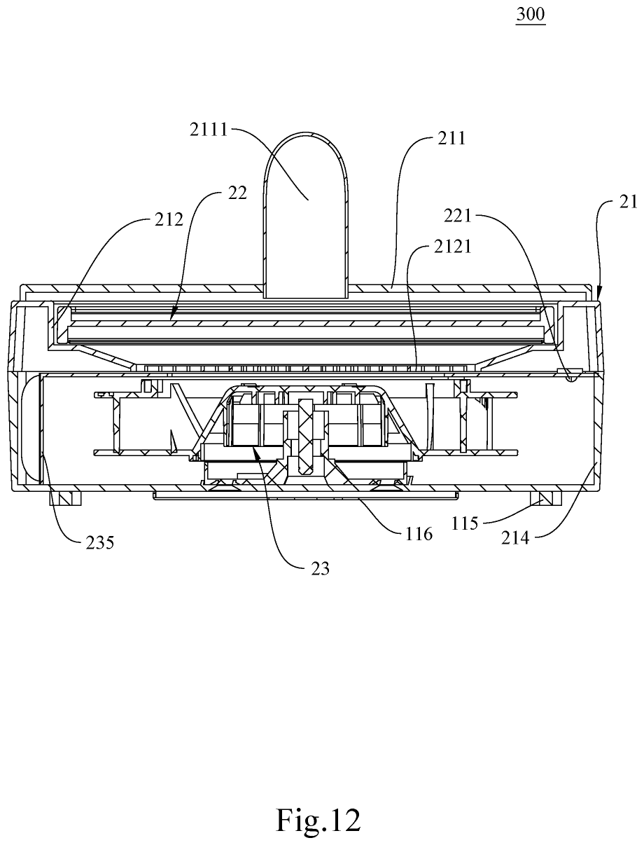

FIG. 11 is a top view of this embodiment, and the airflow channel (i.e. FIG. 12) of the present invention can be understood from the cross section of D-D in the drawing. The arrows A3, A4 shown in FIG. 10 present the air flowing direction. The airflow generation module 23 uses the airflow drawing unit to generate a suction force in order to allow the air containing dust to enter into the dust collector apparatus 300 via the tubular intake vent-hole 2111 at the adjacent side and to contact with the filter 22. The filter 22 then retains the dust particles therein and allows the air to pass through. After the air with the removal of dust passes through the airflow drawing unit, the air then contacts with the airflow guiding drawing unit 235. The airflow guiding drawing unit 235 guides the air with the removal of dust into the at least one exhaust vent-hole 2141 of the housing 21, such that a smooth airflow channel is achieved. The advantage of the third embodiment relies in that the tubular intake vent-hole 2111 is able to further centralize the dust collection target for collection, and it allows the user to adjust the location of the intake vent-hole 2111 according to the user's needs, such that the use convenience of the dust collector apparatus 300 is increased.

IV. Other embodiments of the dust collector apparatus (not shown in the drawings). The other embodiments of the dust collector apparatus not only include the above mentioned characteristics, but also have the following features. For example, in an embodiment, the housing comprises a light diffusing material and a plurality of light emitting diodes is installed in the inner side of the housing. Because the light diffusing property is present on the housing, when light from the light emitting diodes, the light diffusing material scatters the light across the surface area of the housing, causing a more even glow across the entire housing of the dust collector apparatus.

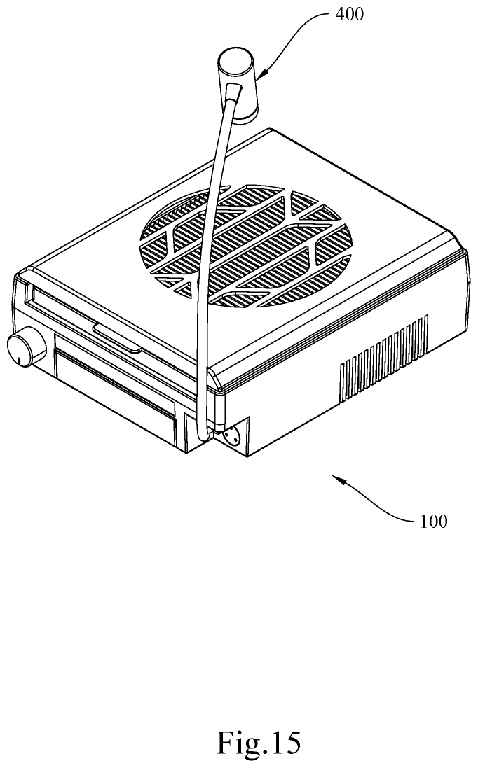

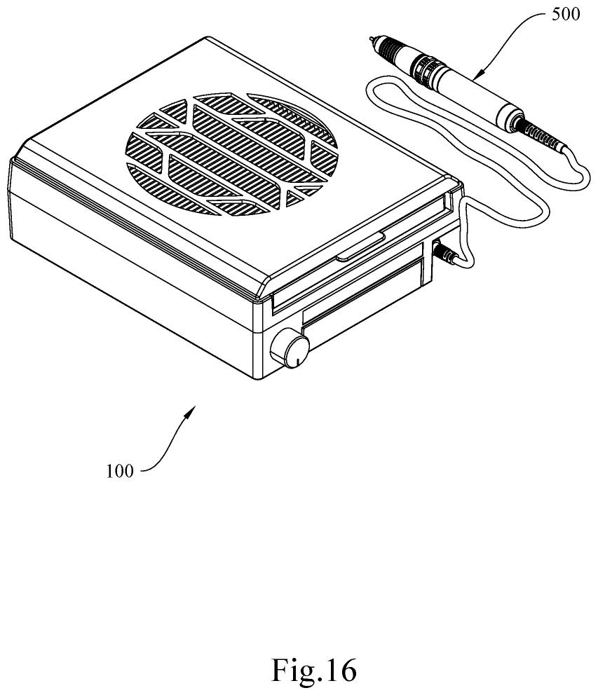

A further embodiment of the dust collector apparatus includes one or more output connectors connected to the power module. These connectors can be used to charge or transmit data from a user's or customer's device, such as a phone or laptop. The user or customer will connect their device (e.g., phone) via a cable to one output connectors and the device will be charged from the power from the power module. If the power input is connected to power, this power is used to charge the user's device (and also the rechargeable battery of dust collector apparatus). When the power input is not connected to power, the user's device is charged by the battery of the dust collector apparatus. As shown in FIG. 15, a light unit 400 can also be detachably installed on dust collector apparatus 100 via the output connectors according to the user's needs. According to FIG. 16, a nail drill machine 500 can also be detachably installed on dust collector apparatus 100 via the output connectors according to the user's needs such that the apparatus can be formed as a “two-in-one” dust collector with nail drilling function. In an embodiment, the light unit or the nail drill machine can be an external part of the dust collector apparatus. A further embodiment of the dust collector apparatus is that the outer surface of the housing has a plurality of holes, such that manicure-related tools can be places into the holes. Examples of the manicure-related tools include but not limited to nail bit, brush, and the like.

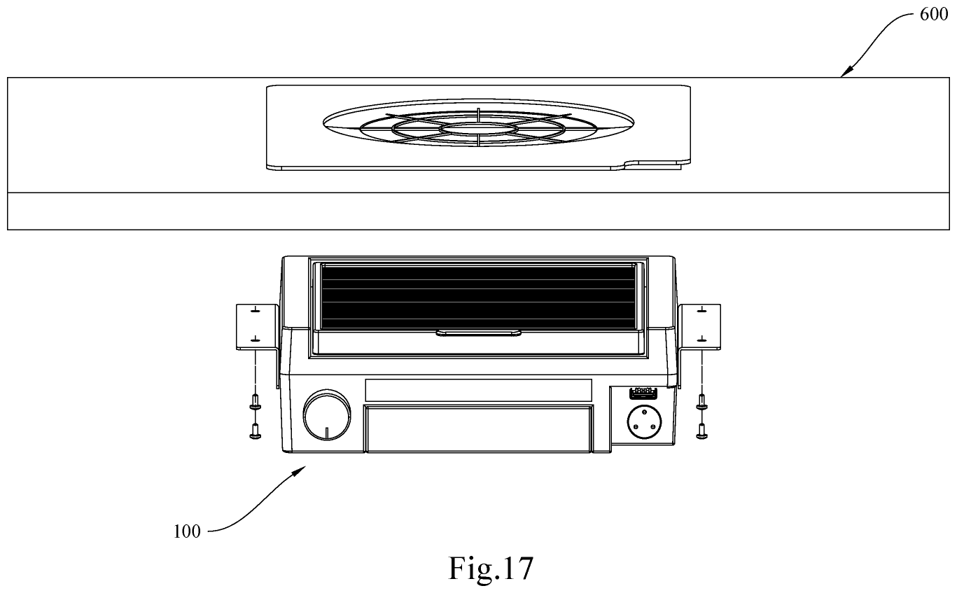

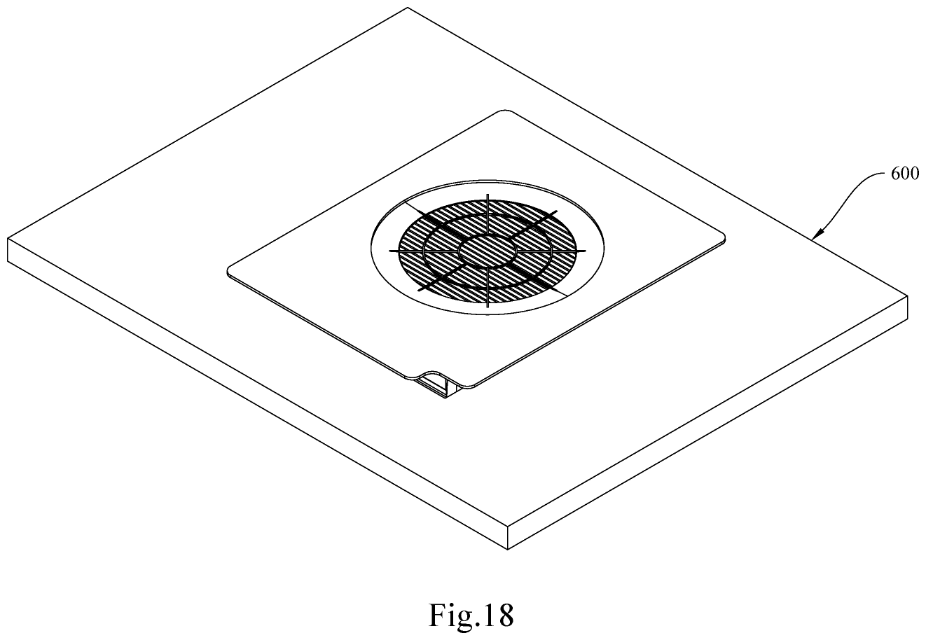

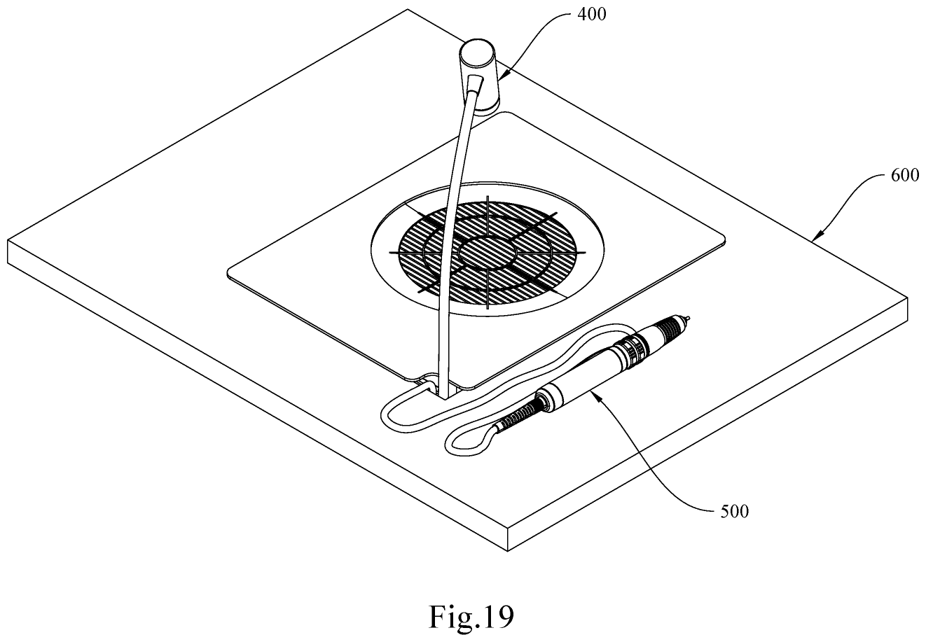

Another embodiment is that the dust collector apparatus 100 is embedded in a table (as shown in FIG. 17, FIG. 18 and FIG. 19). For example, the table includes a planar upper surface having a recess, and the dust collector apparatus is embedded in the recess. The table further includes a cover so that if the dust collector apparatus is not being used, the cover can cover the recess without exposing the dust collector apparatus so that the whole upper surface of the table remains planar.

To sum up, the dust collector apparatus of the present invention can comprise a filter, and such filter can be a composite filter, such as a filter containing photocatalyst, active carbon etc., in order to allow the dust collector apparatus of the present invention to have not only the dust collection function but also the function of deodorization and disinfection on the filtered air, thereby achieving the effect of air purification at the same time. In addition, the dust collector apparatus of the present invention can further include an airflow guiding device for guiding the airflow to be exhausted smoothly in order to maintain the internal airflow inside the apparatus to be smooth without disturbance, thereby allowing the dust particles to be properly collected by the filter without secondary scattering. Furthermore, the dust collector apparatus of the present invention can further include a positioning member in order to confirm that the filter is installed at the correct position immediately during the replacement and installation of the filter.

The above is the detailed description of the present invention. However, the above is merely the preferred embodiment of the present invention and cannot be the limitation to the implement scope of the present invention, which means the variation and modification according to the present invention may still fall into the scope of the invention.

What is claimed is:

1. A dust collector apparatus, comprising:
a housing, having one side formed at least one intake vent-hole and another side formed of at least one exhaust vent-hole, an inner side of the housing having an airflow channel formed between the intake vent-hole and the exhaust vent-hole, wherein the intake vent-hole is in position of a top side of the housing, and the exhaust vent-hole is in position of a lateral side instead of an opposite side aligned to the intake vent-hole of the housing;
an airflow generation module, comprising:
at least one airflow drawing unit for drawing an airflow in order to form the airflow channel between the intake vent-hole and the exhaust vent-hole, the airflow drawing unit having an intake end for sucking an air and an exhaust end for exhausting the air;
a control module electrically connected to the airflow drawing unit, the control module comprising a control board for controlling the airflow drawing unit;
a power module electrically connected to the control module; and
at least one filter detachably arranged at the intake end and used for filtering dust in the air sucked by the airflow drawing unit.

2. The dust collector apparatus according to claim 1, wherein the airflow drawing unit comprises a axial flow fan, the airflow generation module further comprises an airflow guiding drawing unit, the airflow guiding drawing unit comprises an upper airflow guide aligned to an upper side of the axial flow fan, and a lower airflow guide aligned to a bottom side of the axial flow fan.

3. The dust collector apparatus according to claim 2, wherein the upper airflow guide has a bell mouth gradually enlarged from lower side to upper side, the lower air guide has a central protrusion portion aligned to middle of the axial flow fan, and a guiding curved surface surrounding the central protrusion portion to guide the airflow from vertical direction to horizon direction by Coand\check{a} effect.

4. The dust collector apparatus according to claim 3, wherein the upper airflow guide's bottom side is appressed to the upper side of the axial flow fan, a top side of the central protrusion portion is adjacent to the bottom side of the axial flow fan and having a gap in-between.

5. The dust collector apparatus according to claim 4, wherein an opening of the bell mouth is smaller than the axial flow fan, and the diameter of the bell mouth's opening is less than the diameter of the axial flow fan between 1.5 mm to 2.5 mm.

6. The dust collector apparatus according to claim 4, wherein the width of the gap is between 1.5 mm to 2.5 mm, and the height of the central protrusion portion is between 15 mm to 25 mm.

7. The dust collector apparatus according to claim 1, wherein the airflow drawing unit comprises a centrifugal fan, the airflow generation module further comprises an airflow guiding drawing unit for containing the centrifugal fan inside, the airflow guiding drawing unit has a surrounding wall around the periphery of the centrifugal fan, an inlet opening on the top side aligned to the centrifugal fan, and an outlet opening align to a side of the centrifugal fan in a horizontal direction.

8. The dust collector apparatus according to claim 7, wherein the width of the outlet opening is between 85 mm to 95 mm.

9. The dust collector apparatus according to claim 7, wherein the distance between a middle of the centrifugal fan and the surrounding wall is gradually declined from a first lateral side of the outlet opening to a second lateral side of the outlet opening.

10. The dust collector apparatus according to claim 1, wherein the housing has a c-type input plug connected to the control module and/or the power module.

11. The dust collector apparatus according to claim 1, wherein the filter is a filter selected from a group consisting of an absorption layer, filter layer, sedimentation layer, chemical catalyst layer, photocatalyst layer, electrostatic layer, ionization layer or a combination thereof.

12. The dust collector apparatus according to claim 1, wherein the housing comprises a positioning member for positioning the filter, and the positioning member comprises a mortise and tenon joint structure, latch structure, locking engagement structure, space restriction structure, magnetic attraction structure, spring structure, elastic sheet structure, screw fastening structure, sensor or a combination thereof.

13. The dust collector apparatus according to claim 12, wherein the positioning member is a sensor comprising a sensing unit electrically connected to the control module for sensing an installation status of the filter.

14. The dust collector apparatus according to claim 1, wherein the airflow generation module comprises an operation module electrically connected to the control module and is used to control the state of use of the airflow drawing unit.

15. The dust collector apparatus according to claim 1, wherein the power module comprises any one of an external power port, a one-time battery, a rechargeable battery or a combination thereof.

16. The dust collector apparatus according to claim 1, wherein the control module further comprises (a) a detection module and (b) a warning device connected to the detection module; wherein the detection module detects at least one of the following states:
(1) a state of use of the filter, such that when the detection module detects the state of use of the filter exceeding or below a threshold value or the filter is installed at the incorrect position, the detection module transmits a message to a display unit or the warning device in order to display a notice for filter replacement or correction;
(2) a state of the airflow generation module, such that when the detection module detects the airflow generation module is not operated normally, the detection module transmits a message to the display unit or the warning device;
(3) a state of the power module, such that when the detection module detects the power state for the dust collector apparatus is low, the power module does not properly be connected or abnormal power supply, the detection module transmits a message to the display unit or the warning device.

17. The dust collector apparatus according to claim 16, wherein the warning device is selected from the group consisting of a buzzer, a loudspeaker and an indicating light.

18. The dust collector apparatus according to claim 1, wherein the filter has multiple creases on the surface for increasing the contacting area and the containing quantity of the dust.

19. The dust collector apparatus according to claim 1, wherein the housing comprises a handle arranged at an outer side of the housing.

20. The dust collector apparatus according to claim 1, wherein the airflow generation module comprises a supporting layer installed at the intake end of the airflow drawing unit, and the intake vent-hole are formed thereon, the filter is placed between the housing and the supporting layer, the housing has a lateral opening at the side end such that the filter is taken from the lateral opening without dissembling the housing.
